(19) United States
(12) Patent Application Publication
(10) Pub. No.: US 2017/0298684 A1
(43) Pub. Date: Oct. 19, 2017

(54) ACCESSORY FOR PREVENTING A PRE-HUNG DOOR FROM SAGGING IN A DOOR FRAME

(71) Applicant: ISAAC BEN EZRA, West Bloomfield, MI (US)

(72) Inventor: ISAAC BEN EZRA, West Bloomfield, MI (US)

(21) Appl. No.: 14/756,287

(22) Filed: Aug. 21, 2015

(51) Int. Cl. E06B 7/28

(52) U.S. Cl. CPC E06B 7/28

(57) ABSTRACT

An accessory for preventing a pre-hung door from sagging in a door frame comprised of a retainer for supporting one side of the door on a lock jamb of the frame and a bolt which is slideable in the frame for preventing the door from rotating in the frame. The retainer has a “U” shaped portion which receives a lock jamb and an adjoining cylindrical portion which engages a bore in a door. The bolt is an elongated slender member having an enlarged end portion which engages a pocket in the lock jamb and a spur which resists a withdrawal of the bolt from the lock jamb.

### FIELD OF THE INVENTION

This invention relates to door accessories and more particularly to an accessory for preventing a pre-hung door from sagging in a door frame.

### BACKGROUND OF THE INVENTION

It is a common practice to market a pre-hung door in a door frame consisting of jambs and header panels. Only one side of the door is supported on a hinge jamb with a pair of hinges. The pre-hung door is commonly closed with staples and/or adhesive tape. One problem with the current practice is that the pre-hung door tends to sag in the frame because the opposite lock side of the door is unsupported . Another problem is that tapes and staples can mar the appearance of the door.

### SUMMARY OF THE INVENTION

The present invention overcomes door sag by supporting doors on opposite sides to hinge and lock jambs. The lock side is supported on the lock jamb with a retainer and a bolt. The bolt engages the lock jamb and a spur on the bolt prevents the bolt from being easily withdrawn from the jamb. One feature of the invention is changes are not required to doors or jambs.

### BRIEF DESCRIPTION OF THE DRAWINGS

FIG. 1 is a plan view of a retainer for preventing a pre-hung door from sagging in a door frame.

FIG. 2 is a rear view of the retainer.

FIG. 3 is a front view of the retainer.

FIG. 4 is a cross-sectional view taken on the line 4-4 in FIG. 1.

FIG. 5 is a plan view of a bolt which is used with the retainer.

FIG. 6 is a rear view of the bolt.

FIG. 7 is a front view of the bolt.

FIG. 8 is a left side view of the bolt.

FIG. 9 shows the steps for using the invention.

FIG. 10 is a fragmentary view of a door and jamb in according to the invention.

FIG. 11 is.a cross-sectional view taken on the line 11-11 in FIG. 10.

### DETAILED DESCRIPTION OF A PREFERRED EMBODIMENT

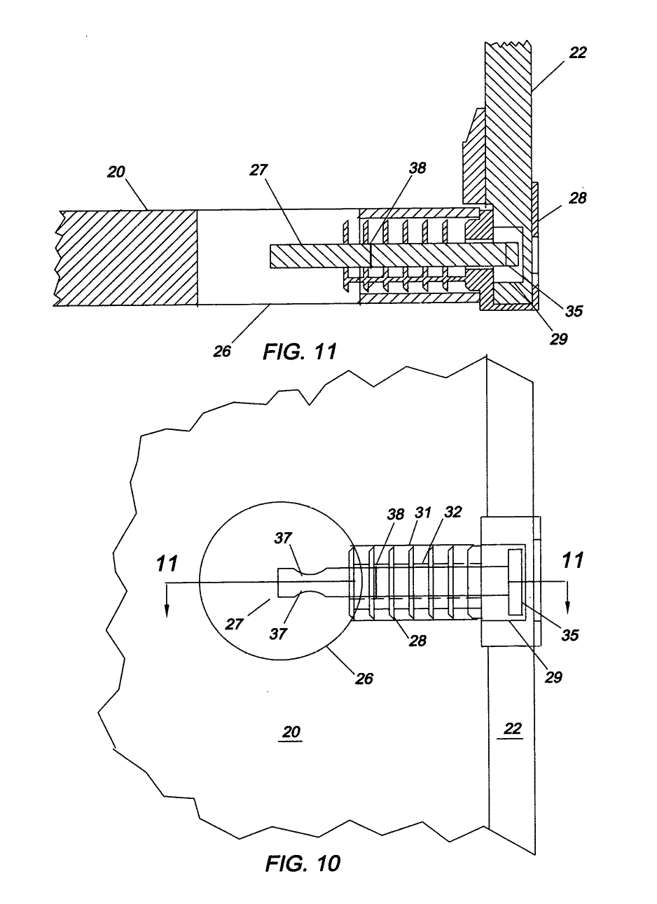

Referring now to the drawings wherein like numerals designate like and corresponding views throughout the several views, In FIGS. 10 and 11, a door 20 is shown mounted in a frame 21 according to the invention. The door 20 and frame 21 are conventional. On one side of a lock jamb 22 is a depression 23 for a lock strike plate (not shown). Extending into the strike plate depression 23 is a pocket 24 for a lock strike (not shown). A pair of intersecting bores 25, 26 are in the door 20 for a door lock (not shown). The door is connected as shown in FIGS. 10 and 11 to the lock jamb 22 with a bolt 27 and a retainer 28. The opposite side of the door (not shown) is connected to a hinge jamb with a pair of hinges. The bolt 27 and retainer 28 are preferably molded plastic parts.

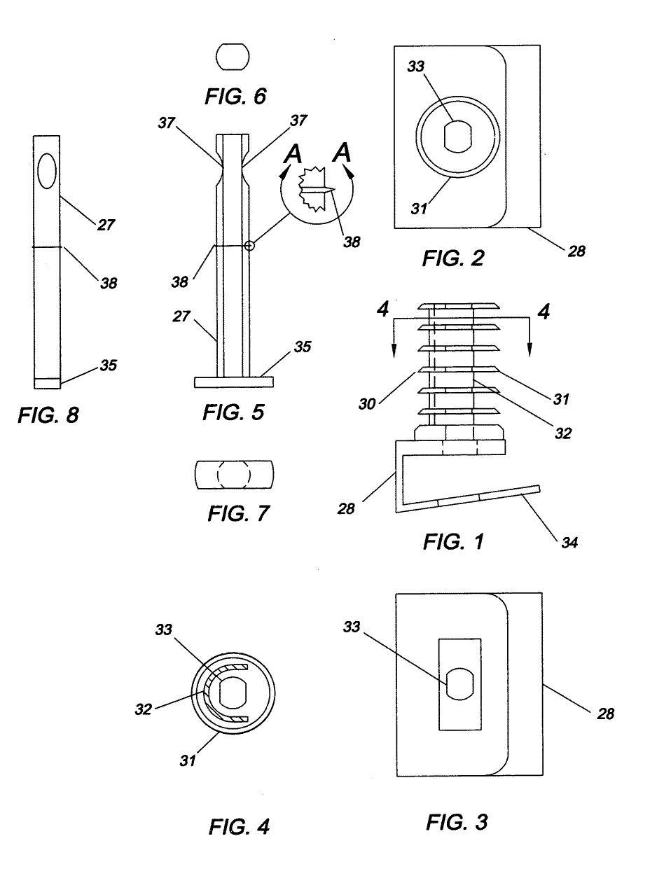

The details of the bolt 27 and retainer 28 are shown in FIGS. 1 to 8. The retainer 28 has a “U” shaped portion 29 and an adjoining cylindrical portion 30. The cylindrical portion 30 is divided into a series of circular ribs 31 and connecting portions 32 to reduce the amount of plastic. In each of the ribs 31 is an aperture 33 which receives the bolt 27. The aperture 33 is asymmetrical to prevent the bolt 27 from rotating in the retainer 28. One leg 34 of the “U” shaped portion 29 is inclined as will be shown to tightly retain the retainer 28 on the lock jamb 22.

With reference to FIGS. 4 through 8, the bolt 27 is a slender elongated cylindrical member with an enlarged end portion 35. As shown in FIG. 6, the cross-section of the bolt 27 matches the aperture 33 in the ribs 31 of the retainer 28. At one end portion of the bolt 27 are a pair of finger depressions 37 which are used for moving the bolt 27 in the retainer 28. Referring to FIG. 5, on the circumference of the bolt 27 there is a spur 38 which as will be shown resists a withdrawal of said bolt from the lock jamb 22. An enlarged view of the spur 38 is shown in circle A-A.

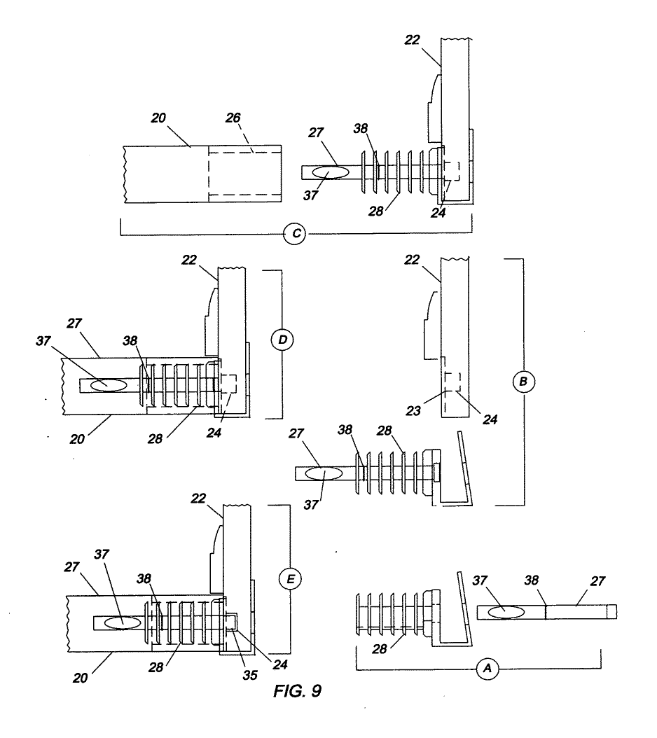

The method of using the invention is shown in FIG. 9. The first step (step “A”) consists of installing the bolt 27 in the retainer 28. The bolt 27 is forced into one end of the retainer 28 as shown in FIG. 9. As will be shown, the spur 38 resists the bolt 27 from being withdrawn from the lock jamb 22. Note: The spur 38 is compressed during the forcible insertion of the bolt 27 into the retainer 28. The next step (step “B”) is to align the retainer 28 with the strike plate depression 23 and install the retainer 28 in the lock jamb 22 .

The third step (step “C”) is to align the retainer 28 with bore 26 in the end of the door 20. The fourth step (step “D”) is to install the retainer 28 in the door 20. The final step is to grasp the bolt 27 with the finger depressions 37 and move toward the lock jamb 22 to engage the enlarged end 35 of the bolt 27 with the pocket 24 in the lock jamb 22.

From the above it is apparent that what I have invention is a means for preventing sag of pre-hung doors that is non-obvious, effective and easy to use. Although only a single embodiment has been illustrated and described, it is obvious that other embodiments can be developed from my disclosure by mere changes in features such as materials, shape, omissions and substitution of parts that are known and obvious to ordinary persons skilled in the art.

What I claim is new is:

1. An accessory for preventing a pre-hung door from sagging in a door frame comprising: a bolt and a retainer, said bolt having a slender elongated body portion, an enlarged end portion and a pair of finger depressions; said retainer having a “U” shaped portion, an adjoining cylindrical portion and an aperture extending along an axis of said cylindrical body portion.

2. The accessory recited in claim 1 wherein said bolt and said retainer are molded plastic parts.

3. The accessory recited in claim 1 further comprising a spur on said bolt for resisting a withdrawal of said bolt from a pocket in said frame.

4. The accessory recited in claim 1 wherein said cylindrical portion of said retainer is comprised of circular rib portions and connecting portions.

5. An accessory for preventing a pre-hung door from sagging in a door frame comprising: a retainer for supporting one end of said door on a lock jamb and a bolt for supporting said retainer on a lock jamb.

6. An accessory for preventing a pre-hung door from sagging in a door frame comprising a means for supporting one side of a door on a lock jamb of a door frame.

7. The accessory recited in claim 6 wherein said means is comprised of a bolt and a retainer.

8. The accessory recited in claim 6 wherein said retainer supports one side of said door on a lock jamb and said bolt engages said retainer with a pocket in said door jamb.

9. The accessory recited in claim 6 wherein said retainer is comprised of a “U” shaped portion and an adjoining cylindrical portion.

10. The accessory recited in claim 6 wherein said bolt is an elongated slender cylindrical member with an expanded end portion.
